(19) United States
(12) Patent Application Publication
(10) Pub. No.: US 2025/0211392 A1
(43) Pub. Date: Jun. 26, 2025

(54) METHOD AND APPARATUS FOR A POSITIONING SIGNAL

(71) Applicant: Samsung Electronics Co., Ltd., Suwon-si, Gyeonggi-do (KR)

(72) Inventors: Qi XIONG, Beijing (CN); Pengru LI, Beijing (CN); Feifei SUN, Beijing (CN)

(21) Appl. No.: 18/852,858

(22) PCT Filed: Mar. 29, 2023
(86) PCT No.: PCT/KR2023/004152

§ 371 Date: Sep. 30, 2024

(30) Foreign Application Priority Data
Apr. 1, 2022 (CN) 202210348662.2

(51) Int. Cl. H04L 5/00; H04W 64/00

(52) U.S. Cl. CPC H04L 5/0051; H04L 5/0085; H04W 64/006

(57) ABSTRACT

The disclosure relates to a 5G or 6G communication system for supporting a higher data transmission rate. The disclosure provides a method performed by a user equipment (UE) and a user equipment. The method comprises: determining whether a conflict condition is satisfied or whether a conflict occurs based on resources related to a first signal and resources related to a reference signal for positioning: transmitting and/or receiving the first signal and/or the reference signal for positioning based on the result of the determination.

### TECHNICAL FIELD

The disclosure relates to a method and apparatus for a positioning signal in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA), and sparse code multiple access (SCMA) as advanced access technologies have been developed.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The disclosure may provide a method and apparatus for a positioning signal in a wireless communication system.

### Solution to Problem

According to an embodiment of the disclosure, a method performed by a user equipment UE in a wireless communication system is provided, the method comprises: determining whether a conflict condition is satisfied or whether a conflict occurs based on resources related to a first signal and resources related to a reference signal for positioning; transmitting and/or receiving the first signal and/or the reference signal for positioning based on the result of the determination.

In an implementation, wherein the resources related to the first signal comprise at least one of the following:
resources for transmission and/or reception of the first signal;
configured resources for transmitting and/or receiving the first signal;
resources in which the UE receives information that activates or schedules or triggers the transmission and/or reception of the first signal; or
resources in which the UE determines the presence of the transmission and/or reception of the first signal, and
wherein the resources related to the reference signal for positioning comprise at least one of the following:
resources for the reference signal transmission for positioning;
configured resources for transmitting the reference signal for positioning.

In an implementation, wherein the resources related to the first signal comprise at least one of the following:
a control resource set CORESET and/or a search space of a cell-specific physical downlink control channel PDCCH and/or a physical downlink shared channel PDSCH;
a valid random access occasion RO;
a valid physical uplink shared channel PUSCH occasion PO;
valid PUSCH resources in configured grant small data transmission.

In an implementation, wherein the conflict condition comprises at least one of the following:
a first condition: the resources related to the reference signal for positioning overlap with the resources related to the first signal, or an gap between the resources related to the reference signal for positioning and the resources related to the first signal satisfies a first predetermined relationship;
a second condition: the gap between the resources related to the reference signal for positioning and the resources related to the first signal satisfies a second predetermined relationship;
a third condition: the resources related to the first signal is later than or not earlier than a position by offsetting a second threshold before the resources related to the reference signal for positioning.

In an implementation, wherein the first predetermined relationship is that the gap between the resources related to the reference signal for positioning and the resources related to the first signal is less than a third threshold;
the second predetermined relationship is that the gap between the resources related to the reference signal for positioning and the resources related to the first signal is not greater than a first threshold.

In an implementation, wherein transmitting and/or receiving the first signal and/or the reference signal for positioning based on the result of the determination comprises at least one of the following:

transmitting and/or receiving the first signal if the UE determines that the conflict occurs or the conflict condition is satisfied;
the UE dropping or not transmitting the reference signal for positioning if it is determined that the first condition is satisfied or a conflict occurs according to the first condition, and/or the third condition is not satisfied or no conflict occurs according to the third condition;
the UE transmitting the reference signal for positioning if it is determined that the second condition or the third condition is satisfied, or a conflict occurs according to the second condition or the third condition.

In an implementation, wherein the UE dropping or not transmitting the reference signal for positioning comprises: the UE dropping or not transmitting the reference signal for positioning on the resources where the conflict occurs or on the resource where the conflict condition is satisfied.

In an implementation, wherein:
the resources related to the first signal comprises at least one of the following: the starting position or the ending position of the time domain/frequency domain resources of the transmission and/or reception of the first signal, or the starting or ending position of the time domain/frequency domain resources of the transmission and/or reception of the first signal plus or minus a first time gap/first frequency domain gap,
the resources related to the reference signal for positioning comprises the starting position or the ending position of the time domain/frequency domain resources of the reference signal for positioning, or the starting or ending position of the time domain/frequency domain resources of the reference signal for positioning plus or minus a second time gap/second frequency domain gap.

According to an embodiment of the disclosure, a user equipment UE is provided, the UE includes: a transceiver; and a processor coupled to the transceiver and configured to implement the methods according to the disclosure.

### Advantageous Effects of Invention

The disclosure may provide a method and apparatus for a positioning signal in a wireless communication system.

### BRIEF DESCRIPTION OF DRAWINGS

FIG. 1 illustrates an example wireless network according to an embodiment of the disclosure;

FIG. 2a illustrates an example wireless transmission path according to an embodiment of the disclosure;

FIG. 2b illustrates an example wireless reception path according to an embodiment of the disclosure;

FIG. 3a illustrates an example user equipment according to an embodiment of the disclosure;

FIG. 3b illustrates an example base station according to an embodiment of the disclosure;

FIG. 4 illustrates an example diagram in which a SRSpos conflicts with valid ROs;

FIG. 5 illustrates a flowchart of a method performed by a user equipment (UE) according to an embodiment of the disclosure; and

FIG. 6 illustrates a block diagram of a user equipment for performing a reception measurement method for a positioning signal according to an embodiment of the disclosure.

### MODE FOR THE INVENTION

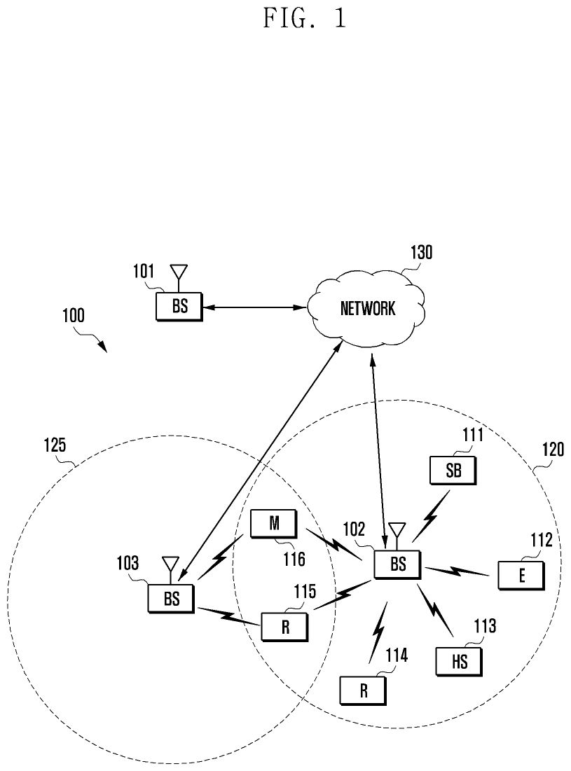

The following description with reference to FIGS. 1-6 is provided to facilitate a comprehensive understanding of various embodiments of the disclosure defined by the claims and their equivalents. The description includes various specific details to facilitate understanding but should only be considered as exemplary. Therefore, those skilled in the art will recognize that various changes and modifications can be made to the various embodiments described herein without departing from the scope and spirit of the disclosure. In addition, for clarity and conciseness, the description of well-known functions and structures may be omitted.

Terms and expressions used in the following specification and claims are not limited to their dictionary meanings, but are only used by the inventors to enable a clear and consistent understanding of the disclosure. Therefore, it should be obvious to those skilled in the art that the following description of various embodiments of the disclosure are provided only for the purpose of illustration and not for the purpose of limiting the disclosure as defined by the appended claims and their equivalents.

It should be understood that singular forms of “a”, “an” and “the” include plural referents, unless the context clearly indicates otherwise. Thus, for example, reference to “a component surface” include reference to one or more such surfaces.

The term “include” or “may include” refers to the presence of corresponding disclosed functions, operations or components that can be used in various embodiments of the disclosure, rather than limiting the presence of one or more additional functions, operations or features. In addition, the term “include” or “have” can be interpreted to indicate certain features, numbers, steps, operations, constituent elements, components or combinations thereof, but should not be interpreted to exclude the possibility of the presence of one or more other features, numbers, steps, operations, constituent elements, components or combinations thereof.

The term “or” used in various embodiments of the disclosure includes any of the listed terms and all combinations thereof. For example, “A or B” may include A, B, or both A and B.

Unless otherwise defined, all terms (including technical terms or scientific terms) used in this disclosure have the same meanings as those understood by those skilled in the art as described in this disclosure. Common terms as defined in dictionaries are interpreted to have meanings consistent with the context in relevant technical fields, and they should not be interpreted as idealized or excessively formally, unless explicitly defined as such in the disclosure.

The technical solution of the embodiments of the present application can be applied to various communication systems, such as: Global System for Mobile Communications (GSM) system, code division multiple access (CDMA) system, Wideband Code Division Multiple Access (WCDMA) system, general packet radio service (GPRS), long term evolution (LTE) system, LTE frequency division duplex (FDD) system, LTE time division duplex (TDD) system, universal mobile telecommunications system (UMTS), worldwide interoperability for microwave access (WiMAX) communication system, 5th generation (5G) system or new radio (NR), etc. In addition, the technical solution of the embodiments of the present application can be applied to future-oriented communication technologies.

FIG. 1 illustrates an example wireless network 100 according to an embodiment of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

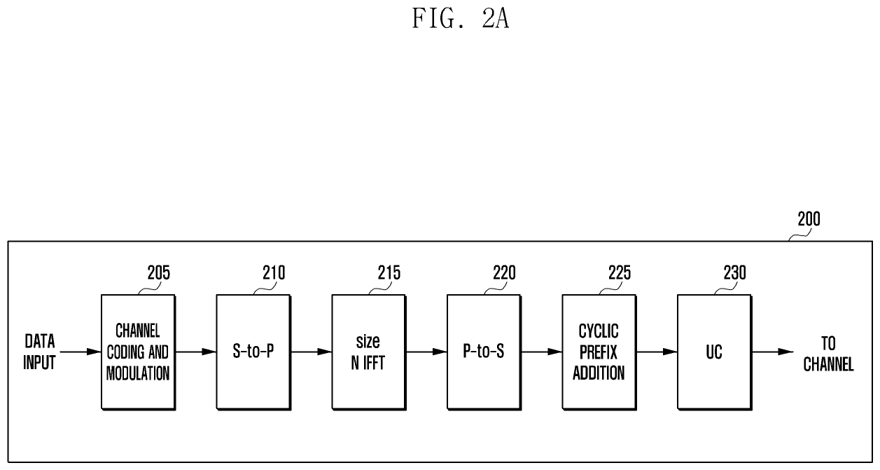

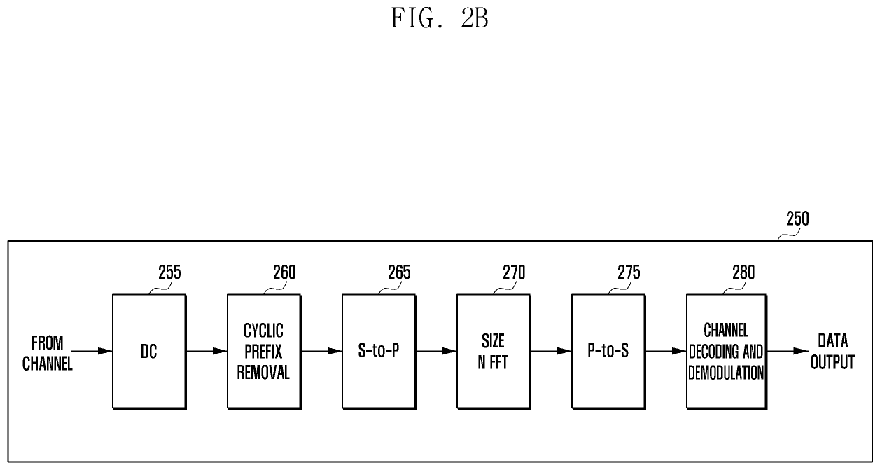

FIGS. 2a and 2b illustrate example wireless transmission and reception paths according to some embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signal. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

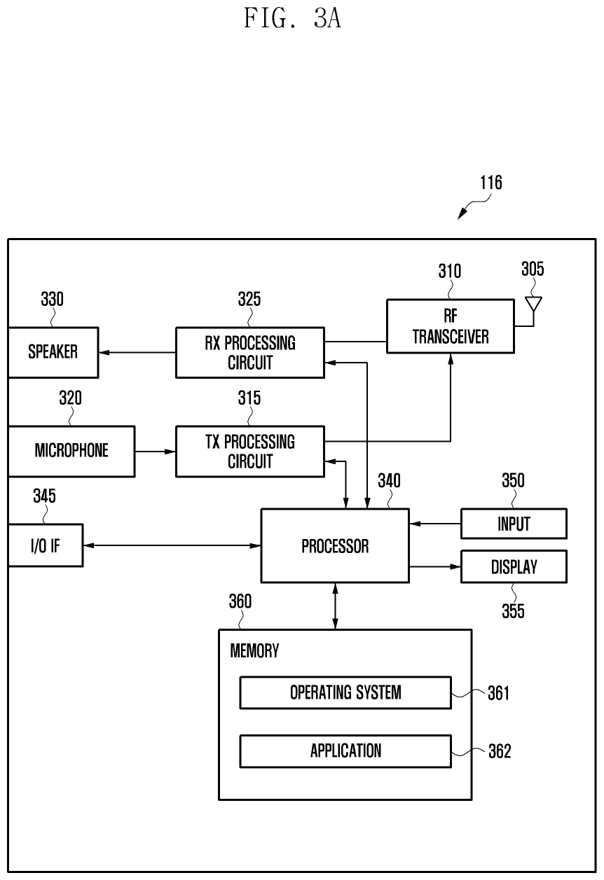

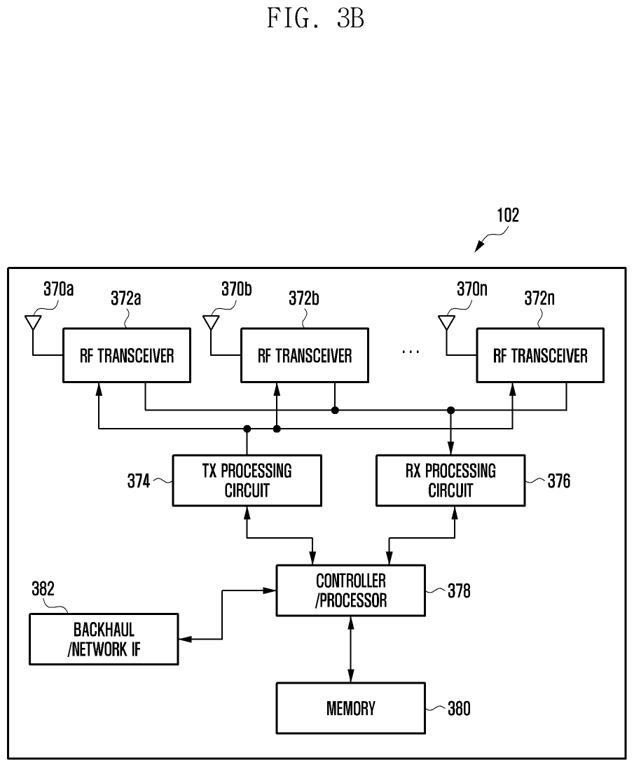

FIG. 3a illustrates an example UE 116 according to an embodiment of the disclosure. The embodiment of UE 116 shown in FIG. 3a is for illustration only, and UEs 111-115 of FIG. 1 can have the same or similar configuration. However, a UE has various configurations, and FIG. 3a does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signal and the transmission of backward channel signal through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signal received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to an embodiment of the disclosure. The embodiment of gNB 102 shown in FIG. 3b is for illustration only, and other gNBs of FIG. 1 can have the same or similar configuration. However, a gNB has various configurations, and FIG. 3b does not limit the scope of the disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signal and the transmission of backward channel signal through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

A time domain unit (also referred to as a time unit) in this application can be a OFDM symbol, a OFDM symbol group (composed of multiple OFDM symbols), a slot, a slot group (composed of multiple slots), a subframe, a subframe group (composed of multiple subframes), a system frame, a system frame group (composed of multiple system frames); it can also be an absolute time unit, such as 1 millisecond, 1 second, etc.; the time unit can also be a combination of various granularity, such as N1 slots plus N2 OFDM symbols.

A frequency domain unit (also referred to as a frequency unit) in this application can be a subcarrier, a subcarrier group (composed of multiple subcarriers), a resource block (RB) (also referred to as a physical resource block (PRB)), a resource block group (composed of multiple RBs), and a bandwidth part (BWP), a bandwidth part group (composed of multiple bandwidth parts), a frequency band/carrier, a frequency band/carrier group; it can also be an absolute frequency domain unit, such as 1 Hz, 1 kHz, etc.; the frequency domain unit can also be a combination of various granularity, such as M1 PRBs plus M2 subcarriers.

The exemplary embodiments of the disclosure are further described below with reference to the accompanying drawings.

Texts and drawings are only provided as examples to help readers understand the disclosure. They are not intended and should not be construed to limit the scope of the disclosure in any way. Although some embodiments and examples have been provided, based on the disclosure herein, it is obvious to those skilled in the art that changes can be made to the illustrated embodiments and examples without departing from the scope of this disclosure.

It can be understood by those skilled in the art that the singular forms “a”, “an”, “said” and “the” used here can also include plural forms unless specifically stated. It should be further understood that the word “comprise” used in the specification of this application means the presence of said features, integers, steps, operations, elements and/or components, but does not exclude the presence or addition of one or more other features, integers, steps, operations, elements, components and/or groups thereof. It should be understood that when we say that an element is “connected” or “coupled” to another element, it may be directly connected or coupled to other elements, or intervening elements may also exist. In addition, as used herein, “connected” or “coupled” may include wireless connection or wireless coupling. The expression “and/or” used here includes all or any unit and all combinations of one or more associated listed items.

It can be understood by those skilled in the technical field that unless otherwise defined, all terms (including technical terms and scientific terms) used here have the same meanings as those commonly understood by those skilled in the art to which this application belongs. It should also be understood that terms such as those defined in general dictionaries should be understood to have meanings consistent with those in the context of the prior art, and will not be interpreted with idealized or overly formal meanings unless specifically defined as here.

It can be understood by those skilled in the art that “terminal”, “terminal device”, “user equipment”, “UE” and so on, as used herein, include both devices equipped with wireless signal receivers (which only have a wireless signal receiver without transmission capability) and devices equipped with a receiving and transmitting hardware (which have a receiving and transmitting hardware capable of bidirectional communication on a bidirectional communication link). Such devices may include cellular or other communication devices, including cellular or other communication devices with or without a single-line display or a multi-line display; Personal Communications Service (PCS), which can combine voice, data processing, fax and/or data communication capabilities; Personal Digital Assistant (PDA), which may include a radio frequency receiver, pager, Internet/Intranet access, web browser, notepad, calendar and/or Global Positioning System (GPS) receiver; conventional laptop and/or palmtop computers or other devices, including conventional laptop and/or palmtop computers or other devices with and/or including a radio frequency receiver. As used herein, “terminal”, “terminal device” and the like can be portable, transportable, installed in vehicles (aviation, maritime and/or land), or suitable for and/or configured to run locally and/or in any other positions on the earth and/or space in a distributed manner. The “terminal” and “terminal device” used herein can also be a communication terminal, an internet terminal, a music/video playing terminal, such as PDA, Mobile Internet Device (MID) and/or a mobile phone with music/video playing function, or a smart TV, set-top box and other devices.

Without departing from the scope of the disclosure, the term “send” in the disclosure can be used interchangeably with “transmit”, “report”, “notify” and the like to express the same or similar meaning, unless it can be clearly determined otherwise according to the context.

The text and drawings are only provided as examples to help readers understand the disclosure. They are not intended and should not be construed to limit the scope of the disclosure in any way. Although some embodiments and examples have been provided, based on the disclosure herein, it is obvious to those skilled in the art that changes can be made to the illustrated embodiments and examples without departing from the scope of this disclosure. Therefore, all such changes fall within the scope of this disclosure.

Transmission links of a wireless communication system mainly includes: the downlink communication link from a 5G gNB to a User Equipment (UE), and the uplink communication link from a UE to the network.

Nodes used for positioning measurement in a wireless communication system, such as current wireless communication system, include: a UE that initiates a positioning request message, a Location Management Function (LMF) used for UE positioning and distribution of positioning assistance data, a gNB or a transmission-reception point (TRP) broadcasting positioning assistance data and performing uplink positioning measurement, and a UE used for downlink positioning measurement. In addition, the method of the disclosure can also be extended to apply to other communication systems, such as automobile communication (V2X), that is, sidelink communication, where the transmission-reception point or the UE can be any device in V2X.

In one embodiment of the disclosure, the method proposed by the disclosure on how to determine whether a conflict occurs and/or how to transmit a signal when the conflict occurs while a reference signal for positioning may conflict with other signal(s), will be introduced. For example, the embodiments according to the disclosure relate to a method of determining whether the reference signal for positioning conflicts with the other signal. In addition, in some embodiments, it also relates to operations performed when it is determined that a conflict occurs, or operations performed when it is determined that no conflict occurs. These operations include sending said other signal under the corresponding circumstances, or dropping or not sending the reference signal for positioning, or dropping a part of the reference signal for positioning. The reference signal for positioning in the disclosure may be a sounding reference signal (SRS) for positioning (hereinafter simply referred to as SRSpos) in an existing communication system, for example, a 5G communication network; or a reference signal for positioning in other communication systems; in the description of the disclosure, an example of using the SRSpos as the reference signal for positioning will be introduced below. It should be understood that this is only an example, and other reference signals for positioning can also be used without departing from the scope of the disclosure.

For convenience of description, in the following description, the above-mentioned “other signal” is referred to as “first signal” or “first channel” or “first signal/channel”. Some examples of the first signal/channel are given in the following description. In addition, for convenience of description, in the following embodiments, a time domain resource location, a time unit, a frequency domain resource location and a frequency domain unit are mainly used as examples of a resource or a resource location, but it should be understood that this is only for convenience of description, and the principles and techniques of the disclosure can also be applied to other types of resources.

In addition, it should be understood that in the communication system that transmits the positioning reference signal, the resource position of the SRSpos will be configured, that is, the SRSpos will be configured at a specific resource position (for example, on some time-frequency resources) for transmission. In actual transmission, due to the consideration of factors such as timing advance and the like in uplink transmission, based on the configured resource locations, the resource locations of the actual transmission of the SRSpos (that is, the resource locations of the SRSpos transmission) can be obtained after considering the factors such as timing advance and the like.

In the following description, the expression “resource location of the SRSpos transmission” is mainly adopted for description, however, it should be understood that the following “resource location of the SRSpos transmission” can also be replaced with “resource location of the SRSpos”. For example, in the case where the first signal also relates to uplink transmission, since timing advance is also applied to transmission of the first signal, at this time, when determining whether the SRSpos satisfies a conflict condition or whether the SRSpos conflicts with the first signal, the resource position of the SRSpos transmission can be compared with the resource position of the first signal transmission. At the same time, since both the SRSpos transmission and the first signal transmission use timing advance, the resource position of the SRSpos can be directly compared with the resource position of the first signal, but it is not necessary to compare the resource position of the SRSpos transmission with the resource position of the first signal transmission.

Therefore, throughout the description of this disclosure, for the sake of brevity, the resource location of “SRSpos transmission” and the resource location of “SRSpos” arc not distinguished, nor are the resource location of “the first signal transmission” and the resource location of “the first signal” distinguished. It can be understood by those skilled in the art that, for example, comparing the resource position of “first signal” with the resource position of “SRSpos”, comparing the resource position of “first signal” with the resource position of “SRSpos transmission”, etc. can each mean comparing the resource position of actually transmitting the SRSpos with the resource position of receiving the first signal or actually transmitting the first signal, or indicate comparing the configured resource position of the SRSpos and the configured resource position of the first signal in case where the first signal is an uplink signal.

According to the embodiments of the disclosure, in a scenario where the SRSpos may conflict with the first signal or channel, the operation of the UE includes a combination of one or more of the following:
The UE performs the determination of the conflict, and a condition for determining the conflict includes a combination of one or more of the following:
   when a first condition is satisfied, that is, when the resources related to the reference signal for positioning overlap with the resources related to the first signal or channel, for example, when the time unit (and/or frequency domain unit) of the SRSpos transmission overlaps with the time domain resource position (and/or frequency domain resource position) of the first signal or channel or the time unit (and/or frequency domain unit) of the first signal or channel transmission and/or reception, the UE confirms that the SRSpos conflicts with the first signal or channel. Wherein the resources related to the reference signal for positioning include resources for reference signal transmission for positioning and/or configured resources for transmitting the reference signal for positioning. The resources related to the first signal include resources of transmission and/or reception of the first signal and/or configured resources for transmitting and/or receiving the first signal;
   when a second condition is satisfied, that is, a time gap between the time unit of the SRSpos transmission and the time unit where UE determines (expects) the transmission and/or reception of the first signal or channel (for example, at this time unit, UE makes the determination or expectation about the transmission and/or reception of the first signal or channel) satisfies a second predetermined relationship (for example, the second predetermined relationship is that the time gap is less than or not greater than a first time unit threshold (for example, a first threshold), UE confirms that the SRSpos conflicts with the first signal or channel; optionally, the time unit where the UE determines (expects) the transmission and/or reception of the first signal or channel further includes the time unit where the UE receives a PDCCH and/or a PDSCH (such as a PDSCH carrying a random access response (RAR) uplink grant (UL GRANT)) that activates or schedules or triggers the transmission and/or reception of the first signal or channel, or the UE performs decoding successfully at this time unit, and knows that there will be transmission and/or reception of the PDCCH and/or the PDSCH after several time units according to the decoding result;
   when a third condition is satisfied, that is, when the time unit where the UE determines (expects) the transmission and/or reception of the first signal or channel is later than or not earlier than X time units (for example, a second threshold, the X or second threshold may be preset or configured by the base station or reported by the UE to the base station) before the time unit of the SRSpos transmission (for example, the position of the time unit where the UE determines (expects) the transmission and/or reception of the first signal or channel is later than or not earlier than the position by offsetting forward the second threshold or X time units with respect to the time unit of the SRSpos transmission), the UE confirms that the SRSpos transmission conflicts with the first signal or channel; for example, in the case where the time unit position (e.g., starting position) of the SRSpos transmission is N, if the time unit position (for example, the start position of the time unit) where the UE determines (expects) the transmission and/or reception of the first signal or channel is after the time unit position N-X, it can be considered that the third condition is satisfied or it is confirmed that the SRSpos transmission conflicts with the first signal or channel; when the third condition is not satisfied, that is, when the time unit where the UE determines (expects) the transmission and/or reception of the first signal or channel is earlier than X time units before the time unit of the SRSpos transmission, the UE confirms that the SRSpos does not conflict with the first signal or channel; optionally, the time unit where the UE determines (expects) the transmission and/or reception of the first signal or channel also includes the time unit where the UE receives the PDCCH and/or PDSCH that activates or schedules or triggers the transmission and/or reception of the first signal or channel (for example, the PDSCH carrying RAR UL GRANT), or the UE performs decoding successfully at this time unit, and knows that there will be transmission of the PDCCH and/or the PDSCH after several time units according to the decoding result.

In some implementations, wherein:
the time unit of the SRSpos transmission also includes the starting position of the first time unit in the time domain resources of the SRSpos transmission and/or the ending position of the last time unit in the time domain resources of the SRSpos transmission; optionally, the gap time unit (or gap, time gap, gap time, etc.) may be additionally considered in the above determination of conflict or the decision of the conflict condition, that is, when determining whether a conflict occurs or whether the conflict condition is satisfied, the time unit of the SRSpos transmission is replaced by considering the time unit of the SRSpos transmission plus or minus or offset the gap time unit, the gap time unit may be before or after the time unit of the SRSpos transmission, that is, the resource position indicated by the starting/ending time unit of the SRSpos transmission plus/minus or offset the gap time unit may be considered. For example, in the second condition, it can be decided whether the time gap between the resource position indicated by the ending time unit of the SRSpos transmission plus/minus or offset the gap time unit and the time unit where the UE determines (expects) the transmission and/or reception of the first signal or channel is smaller than the first threshold, or, it can also be decided whether the time gap between the resource position indicated by the ending time unit of the SRSpos transmission plus/minus the gap time unit and the resource position indicated by the starting or ending time unit where the UE determines (expects) the transmission and/or reception of the first signal or channel plus/minus the gap time unit is smaller than the first threshold. In case of considering the gap time unit, the size of the gap time unit, whether plus or minus the gap time unit is adopted, and whether the starting position or the ending position of the time domain resources is adopted, can be preset, configured by the base station, or reported by the UE to the base station.
the frequency domain unit of the SRSpos transmission also includes the starting position of the first frequency domain unit in the frequency domain resources of the SRSpos transmission and/or the ending position of the last frequency domain unit in the frequency domain resources of the SRSpos transmission; optionally, the gap frequency domain unit may be additionally considered in the above determination of conflict or the determination of the conflict condition, that is, when determining whether a conflict occurs or whether the conflict condition is satisfied, the frequency domain unit of the SRSpos transmission is replaced by considering the frequency domain unit of the SRSpos transmission plus/minus or offset an gap frequency domain unit, the gap frequency domain unit may be above or below the frequency domain unit of the SRSpos transmission, that is, the resource position indicated by the starting/ending frequency domain unit of the SRSpos transmission plus/minus or offset the gap time unit may be considered. For example, in the first condition, it can be decided whether the resource position indicated by the ending frequency domain unit plus/minus or offset the gap frequency domain unit of the SRSpos transmission overlaps with the frequency domain unit of transmission and/or reception of the first signal or channel, or, it can also be decided whether the resource position indicated by the ending frequency domain unit of the SRSpos transmission plus/minus the gap frequency domain unit overlaps with the resource position indicated by the starting or ending frequency domain unit of transmission and/or reception of the first signal or channel plus or minus the gap frequency domain unit. In case of considering the gap frequency domain unit, the size of the gap frequency domain unit, whether plus or minus the gap frequency domain unit is adopted, and whether the starting position or the ending position of the frequency domain resources is adopted, can be preset, or configured by the base station, or reported by the UE to the base station;
the time domain resource position of the first signal or channel also includes the starting position of the first time unit of the time domain resources of the first signal or channel and/or the ending position of the last time unit of the time domain resources of the first signal or channel; optionally, an gap time unit may be additionally considered in the above determination of conflict or the determination of the conflict condition, that is, when determining whether a conflict occurs or whether the conflict condition is satisfied, the time domain resource position of the first signal or channel is replaced by considering the time domain resource position of the first signal or channel plus or minus or offset the gap time unit, and the gap time unit may be before or after the time unit of the first signal or channel, that is, the resource position indicated by the starting/ending time unit of the first signal or channel plus/minus the gap time unit may be considered. In case of considering the gap time unit, the size of the gap time unit, whether plus or minus the gap time unit is adopted, and whether the starting position or the ending position of the time domain resources is adopted, can be preset, configured by the base station, or reported by the UE to the base station;
the frequency domain resource position of the first signal or channel also includes the starting position of the first frequency domain unit of the frequency domain resources of the first signal or channel and/or the ending position of the last frequency domain unit of the frequency domain resources of the first signal or channel; optionally, an gap frequency domain unit may be additionally considered in the above determination of conflict or the determination of the conflict condition, that is, when determining whether a conflict occurs or whether the conflict condition is satisfied, the frequency domain unit of the first signal or channel is replaced by considering the frequency domain unit of the first signal or channel plus/minus or offset the gap frequency domain unit, and the gap frequency domain unit may be above or below the frequency domain unit of the first signal or channel, that is, the resource position indicated by the starting/ending frequency domain unit of the first signal or channel plus/minus the gap frequency domain unit may be considered. In case of considering the gap frequency domain unit, the size of the gap frequency domain unit, whether plus or minus the gap frequency domain unit is adopted, and whether the starting position or the ending position of the frequency domain resources is adopted, can be preset, configured by the base station, or reported by the UE to the base station;
the overlapping also includes that the gap between the time unit (and/or frequency domain unit) of the SRSpos transmission and the time domain resource position (and/or frequency domain resource position) of the first signal or channel or the time unit (and/or frequency domain unit) of the first signal or channel transmission satisfies a first predetermined relationship (for example, the first predetermined relationship is that the gap is less than a time unit (and/or a frequency domain unit) threshold (e.g. a third threshold), which may be preset or configured by the base station or reported by the UE to the base station;
the first signal or channel includes a combination of one or more of the following:
   a downlink signal, for example, the PDCCH that the UE needs to detect, and the control resource set CORESET and/or search space (SS) where the PDCCH is detected (for example, the CORESET and/or SS involved in the detection of the PDCCH), or a PDSCH; SSB (including cell-defining SSB and/or non-cell-defining SSB), CSI-RS, etc. Optionally, the PDCCH may specifically refer to the PDCCH of message 2 in four-step random access, and/or the PDCCH scheduling message 3 retransmission, and/or the PDCCH of message 4, and/or the PDCCH of message B in two-step random access; optionally, the PDSCH may specifically refer to the PDSCH of message 2 in four-step random access, and/or the PDSCH of message 4, and/or the PDSCH of message B in two-step random access; optionally, in RRC_IDLE or RRC_INACTIVE state, the PDCCH may refer to the PDCCH searching for a paging message, and the PDSCH may be a PDSCH carrying a paging message; optionally, the CORESET and/or search space further includes a CORESET and/or search space carrying a cell-specific (for example, UE-common or UE-group-specific) PDCCH and/or PDSCH, such as a common search space (CSS) and/or a common CORESET (such as CORESET 0); that is, even though the UE does not need to perform PDCCH search (i.e., PDCCH reception) in the CSS and/or the common CORESET, the UE needs to avoid interference to the possible reception of other UEs, so it is necessary to consider the problem of the conflict between the reference signal for positioning sent by the UE and the signals of other UEs in the CSS and/or the common CORESET;
   a uplink signal, for example, a PUCCH, includes a PUCCH with high priority or low priority, and/or a PUCCH corresponding to a specific purpose (such as the PUCCH for sending ACK/NACK, including the PUCCH corresponding to message 4 in four-step random access procedure and/or the PUCCH corresponding to message B in two-step random access procedure); and/or a PUSCH, including a PUSCH with high priority or low priority, optionally including the PUSCH of message 3 in random access procedure and/or the PUSCH of message A in two-step random access procedure; and/or a random access channel RACH (and/or a random access preamble transmitted on the random access channel), including the PRACH of message 1 in four-step random access and/or message A in two-step random access; optionally, the random access channel RACH also includes a valid random access occasion (PRACH occasion, RO). That is, the UE does not need to send a preamble on this valid RO, but only needs to decide whether the SRSpos and a valid RO resource satisfy the condition for determining the conflict; optionally, the valid RO may be a valid RO in two-step or four-step random access, or may be replaced by a valid PUSCH occasion (PO) of the PUSCH that sends message A in two-step random access, or valid PUSCH resources in configured grant small data transmission (CG-SDT);
   optionally, the aforementioned (two-step and/or four-step) random access procedure further includes a process of random access small data transmission (RA-SDT);
   optionally, the uplink signal or the downlink signal can be replaced by a sidelink signal in a sidelink communication, for example, a sidelink synchronization signal/channel (e.g., SL-SSB), PSCCH, PSSCH, PSFCH, etc. in a V2X system;
   based on whether the conflict is determined by the UE to have occurred and/or based on whether the condition for the conflict is determined to be satisfied, the UE transmits the SRSpos and/or transmits and/or receives the first signal or channel accordingly, wherein the specific operation modes include the combination of one or more of the following:
      when the UE determines that the conflict occurs and/or the condition for determining the conflict is satisfied, the UE performs a first operation, that is, transmits and/or receives the first signal or channel; in the first operation, for example, the UE may also transmit the SRSpos. Or, in the first operation, the UE may not transmit the SRSpos, or drop the SRSpos;
      optionally, when it is determined according to the first condition that the conflict occurs and/or the first condition is satisfied, and/or when it is determined according to the third condition that no conflict occurs and/or the third condition is not satisfied, the UE performs a second operation, that is, transmits and/or receives the first signal or channel and/or the UE does not transmit (i.e., drops) the SRSpos;

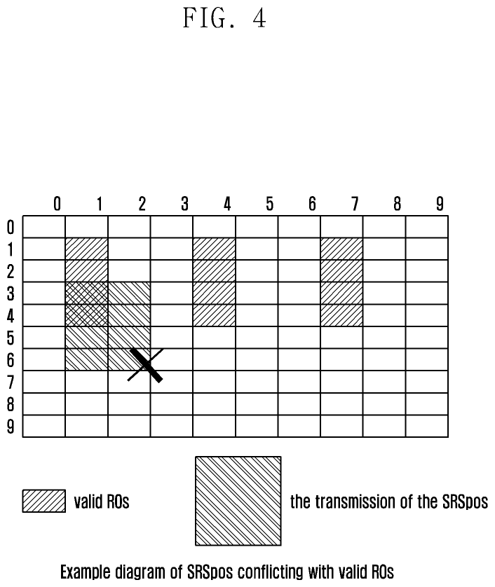

FIG. 4 illustrates an example diagram in which a SRSpos conflicts with valid ROs.

Optionally, when the first signal or channel is a valid RO, that is, when the UE determines that the SRSpos transmission conflicts with the valid RO or satisfies the condition for the conflict, the UE performs not transmitting (i.e., dropping) the SRSpos even if the UE does not perform or does not expect the transmission of random access preamble on the valid RO; as shown in FIG. 4. Because the valid RO can be a random access occasion shared by multiple UEs or all UEs in a cell, this UE does not transmit on this valid RO, but other UEs may choose to transmit on this valid RO. If this UE transmits the SRSpos, and it is finally received at the base station, the SRSpos transmitted by this UE will interfere with the reception of preamble transmitted by other UEs on this valid RO, thus reducing the reception performance. Therefore, when the UE determines that the SRSpos transmission conflicts with the valid RO or satisfies the condition for conflict, the UE performs not transmitting (i.e., dropping) the SRSpos, so that such interference can be avoided. Optionally, the valid RO may be a valid RO in two-step or four-step random access, or may be replaced by a valid PUSCH occasion (PO) of the PUSCH that transmits message A in two-step random access, or valid PUSCH resources in configured grant small data transmission (CG-SDT).

Optionally, when the first signal or channel is a CORESET and/or a search space, such as a common search space (CSS) and/or a common CORESET (such as CORESET 0), which carries a cell-specific (e.g., UE-common or UE-group-specific) PDCCH and/or PDSCH, that is, when the UE determines that the SRSpos conflicts with the time unit and/or frequency domain unit of the common CORESET and/or CSS or satisfies the condition for the conflict, the UE performs not transmitting (that is, dropping) the SRSpos even if the UE does not perform or does not expect to perform downlink reception on the time unit and/or frequency domain unit of the common CORESET and/or CSS, or regardless of whether the UE performs downlink reception on the time unit and/or frequency domain unit of the common CORESET and/or CSS. Such operation can protect downlink reception of other UEs in the time unit and/or frequency domain unit of the common CORESET and/or CSS from being interfered by the SRSpos transmission of the UE.

Optionally, the UE not transmitting (e.g., dropping) the SRSpos further includes the UE not transmitting (e.g., dropping) the SRSpos on the time unit and/or frequency domain unit where the conflict occurs, or the UE not transmitting (e.g., dropping) the SRSpos on the time unit and/or frequency domain unit where the condition for determining the conflict is satisfied.
Optionally, when it is determined according to the second or third condition that the conflict occurs and/or the second or third condition is satisfied, the UE may also (be allowed to) perform a third operation, that is, transmit the SRSpos;
optionally, when the UE is a Time Division Duplex (TDD) UE, or a UE operating in TDD mode, or a UE operating in the unpaired spectrum, when the UE determines that the conflict occurs and/or the condition for determining the conflict is satisfied, the UE performs the above first or second operation; the operation at this time is more in line with the characteristics of the unpaired spectrum in time division duplex;
optionally, when the UE is a Frequency Division Duplex-Half Duplex (HD-FDD) UE or a UE operating in HD-FDD mode, when the UE determines that the conflict occurs and/or the condition for determining the conflict is satisfied, the UE performs transmitting the SRSpos and/or transmitting or receiving the first signal or channel;
optionally, when the UE is a Frequency Division Duplex (FDD) UE, a UE operating in FDD mode, or a UE operating in the paired spectrum, when the UE determines that the conflict occurs and/or the condition for determining the conflict is satisfied, the UE performs transmitting the SRSpos and/or transmitting or receiving the first signal or channel; the operation at this time is more in line with the characteristics of the paired spectrum in frequency division duplex.

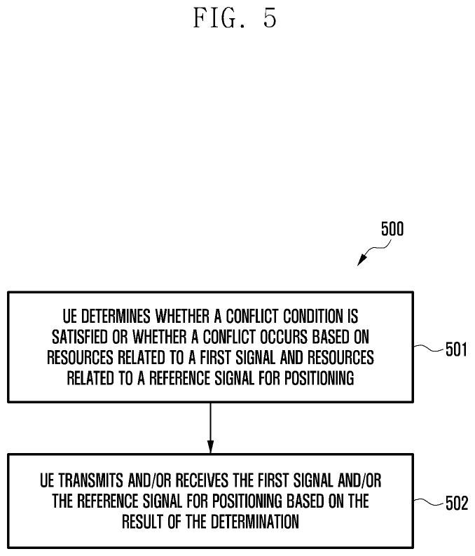

FIG. 5 shows a flowchart of a method 500 performed by a user equipment (UE) according to an embodiment of the disclosure. As shown in FIG. 5, the method 500 includes the following steps:

Step 501, the UE determines whether a conflict condition is satisfied or whether a conflict occurs based on resources related to a first signal and resources related to a reference signal for positioning;

Step 502, the UE transmits and/or receives the first signal and/or the reference signal for positioning based on the result of the determination.

In an implementation, wherein the resources related to the first signal comprise at least one of the following: resources for transmission and/or reception of the first signal; configured resources for transmitting and/or receiving the first signal; resources where the UE receives information that activates or schedules or triggers the transmission and/or reception of the first signal; or resources where the UE determines the presence of the transmission and/or reception of the first signal, and wherein the resources related to the reference signal for positioning comprise at least one of the following: resources for the reference signal transmission for positioning; configured resources for transmitting the reference signal for positioning.

In an implementation, wherein the resources related to the first signal comprise at least one of the following: a control resource set CORESET and/or a search space of a cell-specific physical downlink control channel PDCCH and/or a physical downlink shared channel PDSCH; a valid random access occasion RO; a valid physical uplink shared channel PUSCH occasion PO; valid PUSCH resources in configured grant small data transmission.

In an implementation, wherein the conflict condition comprises at least one of the following: a first condition: the resources related to the reference signal for positioning overlap with the resources related to the first signal, or an gap between the resources related to the reference signal for positioning and the resources related to the first signal satisfies a first predetermined relationship; a second condition: the gap between the resources related to the reference signal for positioning and the resources related to the first signal satisfies a second predetermined relationship; a third condition: the resources related to the first signal is later than or not earlier than the position by offsetting a second threshold before the resources related to the reference signal for positioning.

In an implementation, wherein the first predetermined relationship is that the gap between the resources related to the reference signal for positioning and the resources related to the first signal is less than a third threshold; the second predetermined relationship is that the gap between the resources related to the reference signal for positioning and the resources related to the first signal is not greater than a first threshold.

In an implementation, wherein transmitting and/or receiving the first signal and/or the reference signal for positioning based on the result of the determination comprises at least one of the following: transmitting and/or receiving the first signal if the UE determines that the conflict occurs or the conflict condition is satisfied; the UE dropping or not transmitting the reference signal for positioning if it is determined that the first condition is satisfied or the conflict occurs according to the first condition, and/or the third condition is not satisfied or no conflict occurs according to the third condition; the UE transmitting the reference signal for positioning if it is determined that the second condition or the third condition is satisfied, or the conflict occurs according to the second condition or the third condition.

In an implementation, wherein the UE dropping or not transmitting the reference signal for positioning comprises: the UE dropping or not transmitting the reference signal for positioning on the resources where the conflict occurs or on the resource where the conflict condition is satisfied.

In an implementation, wherein: the resources related to the first signal comprises at least one of the following: the starting position or the ending position of the time domain/frequency domain resources of the transmission and/or reception of the first signal, or the starting or ending position of the time domain/frequency domain resources of the transmission and/or reception of the first signal plus or minus a first time gap/first frequency domain gap, the resources related to the reference signal for positioning comprises the starting position or the ending position of the time domain/frequency domain resources of the reference signal for positioning, or the starting or ending position of the time domain/frequency domain resources of the reference signal for positioning plus or minus a second time gap/second frequency domain gap.

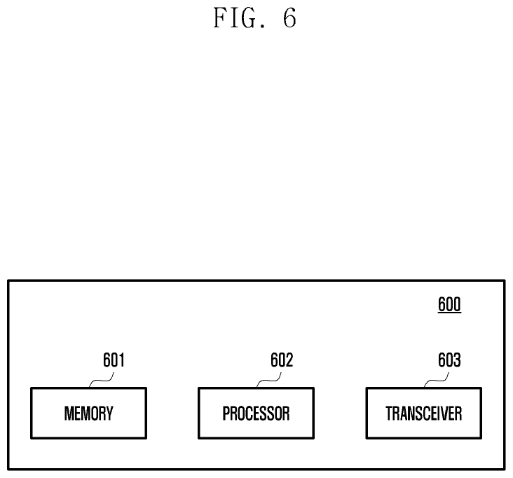

FIG. 6 illustrates a block diagram of a user equipment for performing a reception measurement method for a positioning signal according to an embodiment of the disclosure.

Referring to FIG. 6, an electronic device (a user equipment) 600 for a reception measurement method for a positioning signal is also provided according to the embodiments of the disclosure. The user equipment includes at least one of a memory 601, a processor 602 and a transceiver 603. The processor is coupled with the transceiver and the memory, and the transceiver is used for receiving and/or transmitting signals or information. The memory has stored thereon computer executable instructions which, when executed by the processor 602, perform at least one method corresponding to the above respective embodiment of the disclosure. The above description is only preferred embodiments of the disclosure, and it is not intended to limit the disclosure, any modifications, equivalents, improvements, etc. made within the spirit and principle of the disclosure should be included in the scope of the disclosure.

It can be understood by those skilled in the art that the disclosure includes devices involved in performing one or more of the operations described in this application. These devices can be specially designed and manufactured for the required purpose, or they can also include known devices in general-purpose computers. These devices have computer programs stored therein, which are selectively activated or re-configured. Such computer programs can be stored in device (e.g., computer) readable medium or in any type of medium suitable for storing electronic instructions and respectively coupled to a bus, including but not limited to any type of disk (including floppy disk, hard disk, optical disk, CD-ROM, and magneto-optical disk), Read-Only Memory (ROM), Random Access Memory (RAM), Erasable Programmable Read-only Memory (EPROM), Electrically Erasable Programmable Read-only Memory (EEPROM), flash memory, magnetic card or optical card. That is, readable medium includes any medium that stores or transmits information in a readable form by a device (e.g., a computer).

Those skilled in the art can understand that each block in these structural diagrams and/or block diagrams and/or flow diagrams and combinations of blocks in these structural diagrams and/or block diagrams and/or flow diagrams can be implemented by computer program instructions. It can be understood by those skilled in the art that these computer program instructions can be provided to the processors of general-purpose computers, specialized computers or other programmable data processing methods, so that the schemes specified in the block or blocks of the structural diagrams and/or block diagrams and/or flow diagrams disclosed in the disclosure can be executed by the processors of the computers or other programmable data processing methods.

It can be understood by those skilled in the art that steps, measures and schemes in various operations, methods, and processes that have been discussed in the disclosure can be alternated, changed, combined or deleted. Further, other steps, measures, and schemes in various operations, methods, and processes that are already discussed in the disclosure can also be alternated, modified, rearranged, decomposed, combined, or deleted. Further, the steps, measures and schemes in the prior art with various operations, methods and processes disclosed in the disclosure can also be alternated, modified, rearranged, decomposed, combined or deleted.

The above are only some implementations of the disclosure, it should be pointed out that for those of ordinary skills in the art, without departing from the principles of the disclosure, several improvements and embellishments can be made, and these improvements and embellishments should also be regarded as in the protection scope of the disclosure.

1. A method performed by a terminal in a communication system, the method comprising:
determining whether a conflict condition is satisfied or whether a conflict occurs based on resources related to a first signal and resources related to a reference signal for positioning; and
communicating, based on a result of the determination, at least one of the first signal or the reference signal for positioning.

2. The method of claim 1, wherein the resources related to the first signal comprise at least one of:
resources for communicating the first signal;
configured resources for communicating the first signal;
resources where the UE receives information that activates or schedules or triggers communication of the first signal; or
resources where the UE determines a presence of the communication of the first signal, and
wherein the resources related to the reference signal for positioning comprise at least one of the following:
resources for the reference signal transmission for positioning; or
configured resources for transmitting the reference signal for positioning.

3. The method of claim 1, wherein the resources related to the first signal comprise at least one of the following:
at least one of: a control resource set (CORESET), a search space of a cell-specific physical downlink control channel (PDCCH) or a physical downlink shared channel (PDSCH);
a valid random access occasion (RO);
a valid physical uplink shared channel (PUSCH) occasion (PO); or
valid PUSCH resources in configured grant small data transmission.

4. The method of claim 1, wherein the conflict condition comprises at least one of the following:
a first condition including the resources related to the reference signal for positioning overlap with the resources related to the first signal, or a gap between the resources related to the reference signal for positioning and the resources related to the first signal satisfies a first predetermined relationship;
a second condition including the gap between the resources related to the reference signal for positioning and the resources related to the first signal satisfies a second predetermined relationship; or
a third condition including the resources related to the first signal is later than or not earlier than a position by offsetting a second threshold before the resources related to the reference signal for positioning.

5. The method of claim 4, wherein the first predetermined relationship is that the gap between the resources related to the reference signal for positioning and the resources related to the first signal is less than a third threshold; and
wherein the second predetermined relationship is that the gap between the resources related to the reference signal for positioning and the resources related to the first signal is not greater than a first threshold.

6. The method of claim 4, wherein communicating the at least one of the first signal or the reference signal for positioning comprises at least one of the following:
communicating the first signal in case of determining that a conflict occurs or the conflict condition is satisfied;
dropping or determining not to transmit the reference signal for positioning in case of determining that the first condition is satisfied or a conflict occurs according to at least one of the first condition, or the third condition is not satisfied or no conflict occurs according to the third condition; or
transmitting the reference signal for positioning in case of determining that the second condition or the third condition is satisfied, or a conflict occurs according to the second condition or the third condition.

7. The method of claim 6, wherein dropping or determining not to transmit the reference signal for positioning comprises: dropping or determining not to transmit the reference signal for positioning on the resources where the conflict occurs or on the resource where the conflict condition is satisfied.

8. The method of claim 1, wherein the resources related to the first signal comprises at least one of the following: a starting position or an ending position of at least one of the time domain resources or frequency domain resources for communicating the first signal, or an starting position or an ending position of the at least one of time domain resources or frequency domain resources for communicating the first signal plus or minus at least one of a first time gap or a first frequency domain gap, and
wherein the resources related to the reference signal for positioning comprises a starting position or an ending position of at least one of time domain resources or frequency domain resources for the reference signal for positioning, or a starting position or an ending position of the at least one of time domain resources or frequency domain resources for the reference signal for positioning plus or minus at least one of a second time gap or a second frequency domain gap.

9. A terminal in a communication system, the terminal comprising:
a transceiver, and
a processor coupled to the transceiver and configured to:
determine whether a conflict condition is satisfied or whether a conflict occurs based on resources related to a first signal and resources related to a reference signal for positioning; and
communicate, based on a result of the determination, at least one of the first signal or the reference signal for positioning.

10. The terminal of claim 9, wherein the resources related to the first signal comprise at least one of:
resources for communicating the first signal;
configured resources for communicating the first signal;
resources where the UE receives information that activates or schedules or triggers communication of the first signal; or
resources where the UE determines a presence of the communication of the first signal, and
wherein the resources related to the reference signal for positioning comprise at least one of the following:
resources for the reference signal transmission for positioning; or
configured resources for transmitting the reference signal for positioning.

11. The terminal of claim 9, wherein the resources related to the first signal comprise at least one of the following:
at least one of: a control resource set (CORESET), a search space of a cell-specific physical downlink control channel (PDCCH) or a physical downlink shared channel (PDSCH);
a valid random access occasion (RO);
a valid physical uplink shared channel (PUSCH) occasion (PO); or
valid PUSCH resources in configured grant small data transmission.

12. The terminal of claim 9, wherein the conflict condition comprises at least one of the following:
a first condition including the resources related to the reference signal for positioning overlap with the resources related to the first signal, or a gap between the resources related to the reference signal for positioning and the resources related to the first signal satisfies a first predetermined relationship;
a second condition including the gap between the resources related to the reference signal for positioning and the resources related to the first signal satisfies a second predetermined relationship; or
a third condition including the resources related to the first signal is later than or not earlier than a position by offsetting a second threshold before the resources related to the reference signal for positioning.

13. The terminal of claim 12, wherein the first predetermined relationship is that the gap between the resources related to the reference signal for positioning and the resources related to the first signal is less than a third threshold; and
wherein the second predetermined relationship is that the gap between the resources related to the reference signal for positioning and the resources related to the first signal is not greater than a first threshold.

14. A method performed by a base station in a communication system, the method comprising:
transmitting configuration information related to positioning; and
communicating at least one of a first signal or a reference signal for positioning associated with the configuration information in case that a conflict condition is satisfied or a conflict occurs,
wherein the conflict condition or the conflict is related to resources related to the first signal and resources related to the reference signal for positioning.

15. A base station in a communication system, the base station comprising:
a transceiver, and
a processor coupled to the transceiver and configured to:
transmit configuration information related to positioning; and
communicate at least one of a first signal or a reference signal for positioning associated with the configuration information in case that a conflict condition is satisfied or a conflict occurs,
wherein the conflict condition or the conflict is related to resources related to the first signal and resources related to the reference signal for positioning.
